(19) United States
(12) Patent Application Publication
(10) Pub. No.: US 2015/0008166 A1
(43) Pub. Date: Jan. 8, 2015

(54) SIFTING AND GRADING DEVICE

(71) Applicants: SHENZHEN FUTAIHONG PRECISION INDUSTRY CO., LTD., Shenzhen (CN); FIH (Hong Kong) Limited, Kowloon (HK)

(72) Inventors: ZHI-JIN MA, Shenzhen (CN); BING YU, Shenzhen (CN); JIAN-PING JIN, Shenzhen (CN)

(21) Appl. No.: 14/325,496

(22) Filed: Jul. 8, 2014

(30) Foreign Application Priority Data
Jul. 8, 2013 (CN) 2013102841276

(51) Int. Cl. B07C 5/342

(52) U.S. Cl. CPC B07C 5/3425
USPC 209/580

(57) ABSTRACT

A sifting and grading device includes an accommodation module, a pushing module, a detection module, an image unit, and a transmission module. The accommodation module is used to accommodate pellets and convey the pellets to the pushing module. The pushing module is connected to the accommodation module to move the pellets to the detection module. The detection module includes a rotation box. The image unit is positioned above the rotation box and electrically connected to the transmission module. The image unit controls the transmission module to switch among different motion states according to colors of light reflected by the pellets, thereby driving the rotation box to rotate towards different directions.

### FIELD

The disclosure generally relates to sifting and grading devices.

### BACKGROUND

In industrial production, different pellets are sifted according to color, grade, or other criteria by manual operation, thus causing inefficiency and human waste.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the disclosure.

FIG. 1 is an assembled, isometric view of an embodiment of a sifting and grading device.

FIG. 2 is an assembled, isometric exploded view of the sifting and grading device shown in FIG. 1.

FIG. 3 is an isometric view of an accommodation module shown in FIG. 2.

FIG. 4 is a cutaway view of FIG. 1.

FIG. 5 is an enlarged view of circled portion V shown in FIG. 4.

### DETAILED DESCRIPTION

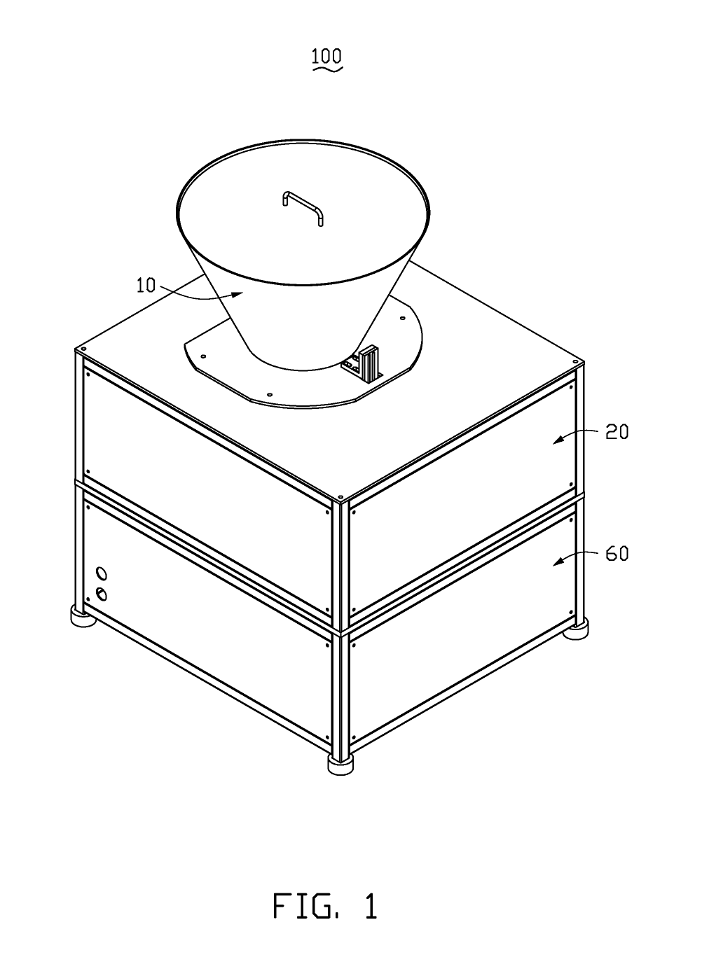

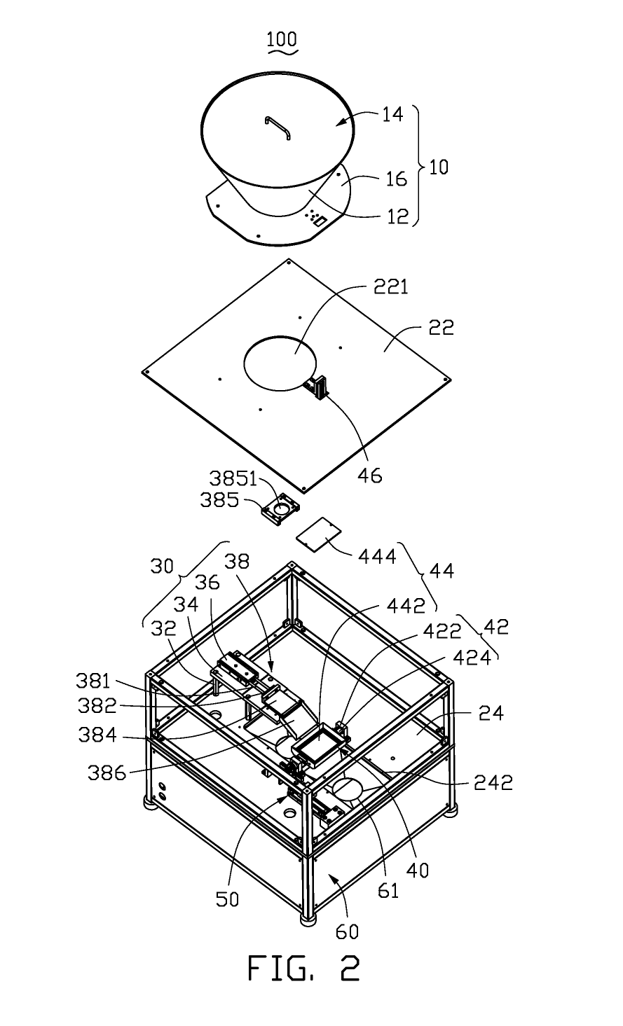

FIG. 1 illustrates an embodiment of a sifting and grading device 100, which is used to sift and grade pellets according to colors of the pellets. Referring to FIG. 2, the sifting and grading device 100 includes an accommodation module 10, a first housing 20, a pushing module 30, a detection module 40, a transmission module 50, and a second housing 60. The accommodation module 10 is mounted to the first housing 20, and the pushing module 30, the detection module 40, and the transmission module 50 are accommodated in the first housing 20. The second housing 60 is positioned under the first housing 20.

Referring to FIG. 2, the first housing 20 includes a first plate 22 and a second plate 24. The first plate 22 defines a mounting hole 221 to receive the narrow end portion of the funnel 12. The fixing plate 16 is mounted to the first plate 22, thereby mounting the accommodation module 10 to the first housing 20. The second plate 24 defines an opening 242.

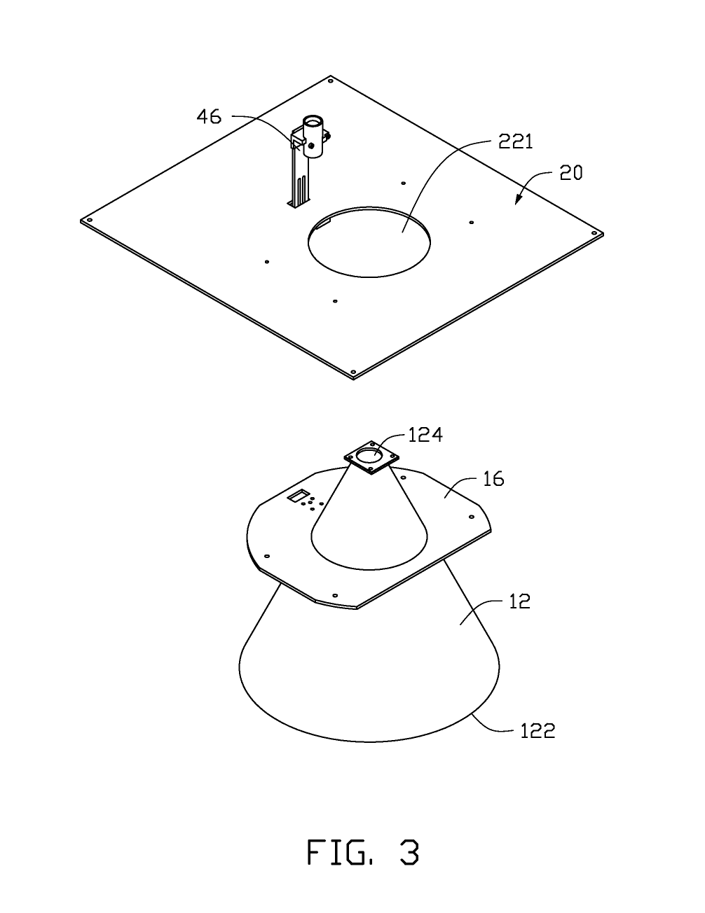

The accommodation module 10 comprises a funnel 12, a cover 14, and a fixing plate 16. Referring to FIG. 3, a wide end portion of the funnel 12 defines an inlet 122, and a narrow end portion of the funnel 12 defines an outlet 124. A size of the inlet 122 is greater than a size of the outlet 124. The cover 14 covers the inlet 122 to prevent the pellets from spilling out of the inlet 122. The fixing plate 16 is sleeved on the narrow end portion of the funnel 12.

The pushing module 30 pushes the pellets to the detection module 40. The pushing module 30 includes a plurality of supporting pillars 32, a supporting plate 34, a first driving member 36, and a pushing assembly 38. The supporting pillars 32 support the supporting plate 34 above the second plate 24. The first driving member 36 and the pushing assembly 38 are supported on the supporting plate 34. The first driving member 36 is connected to the pushing assembly 38 to move the pushing assembly 38. The pushing assembly 38 comprises at least one pushing rod 381, a connection block 382, a connection plate 384, an accommodation block 385, and a chute 386. In the illustrated embodiment, there are two pushing rods 381, in another embodiment there can be a plurality of pushing rods. The pushing rods 381 are connected to the first driving member 36, and the first driving member 36 drives the pushing rods 381 to extend or retract. The connection block 382 is fixed to the pushing rods 381, and the connection plate 384 is fixed to the connection block 382. The accommodation block 385 defines a feeding hole 3851. The feeding hole 3851 can allow the pellets to drop through the accommodation block 385 after the pellets exit out of the funnel 12 through the outlet 124. The accommodation block 385 is fixed to the supporting plate 34 and positioned above the connection plate 384, such that the first driving member 36 can move the connection plate 384 between the accommodation block 385 and the supporting plate 34. The chute 386 is fixed to the accommodation block 385. When the pellets are conveyed to the connection plate 384, the first driving member 36 pushes the connection plate 384 to the chute 386. The pellets drop through the chute 386 as a result of a pushing force of the first driving member 36 on the chute 36.

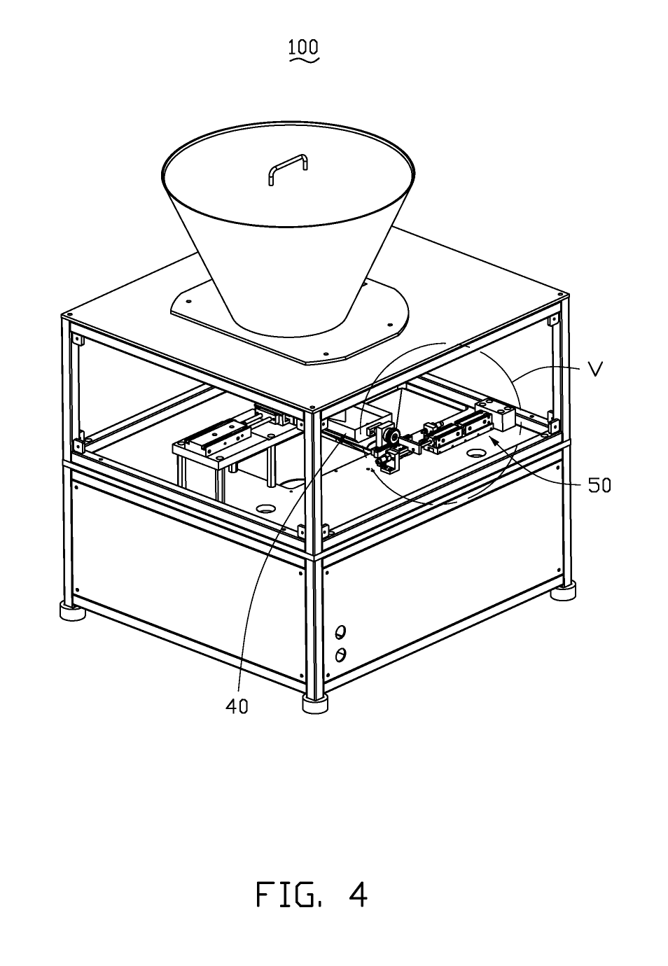

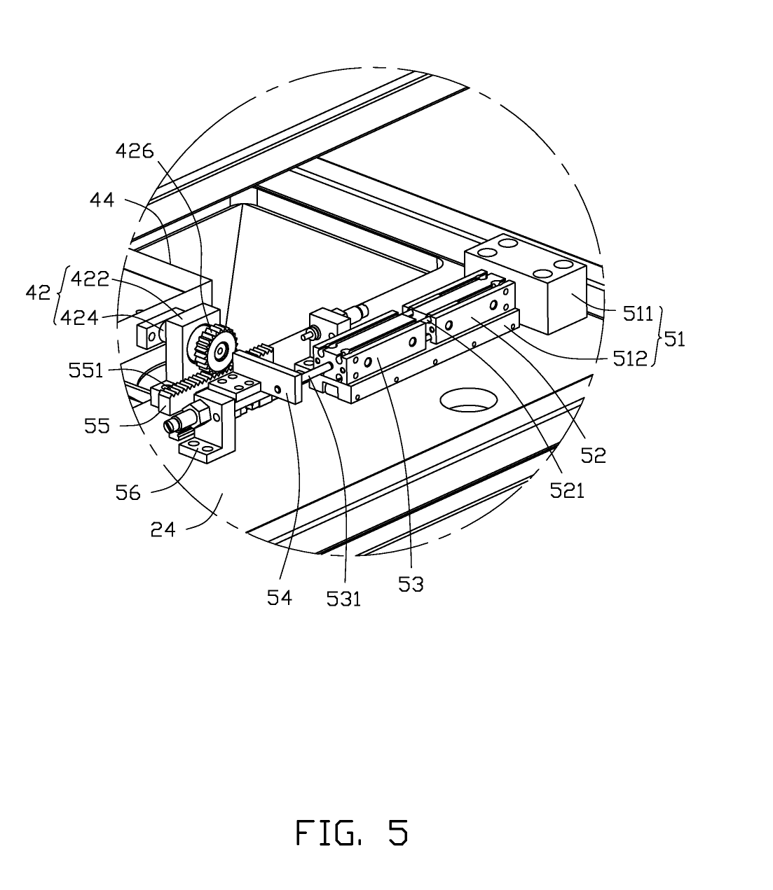

Referring to FIG. 4, the detection module 40 is positioned in a side of the transmission module 50 and below an end of the chute 386. The detection module 40 includes a base 42 and a rotation box 44. The base 42 includes two fixing blocks 422 and two connection rods 424. The two fixing blocks 422 are fixed to the second plate 24 of the first housing 20 and positioned at opposite sides of the opening 242. A first end of each connection pole 424 is rotatably connected to the corresponding fixing block 422, and a second end of each connection pole 424 is connected to the rotation box 44 to suspend the rotation box 44 below an end of the chute and above the opening 242. Referring to FIG. 5, one of the connection rods 424 extends through the corresponding fixing block 422 and is rotatably connected to a gear 426. The gear 426 is driven by the transmission module 50 to rotate the rotation box 44. In at least one exemplary embodiment, the rotation box 44 can rotate about 90 degrees.

The rotation box 44 includes an illuminant 442 and a transparent panel 444. The pellets land on the transparent panel 444 from the chute 386, and the illuminant 442 illuminates the transparent panel 444. The pellets can reflect colored lights when illuminated. An image unit 46 is positioned above the rotating box 44 and fixed to the first plate 22 to detect the colored lights reflected by the pellets. The image unit 46 is electrically connected to the transmission module 50 to control movements of the transmission module 50 according to the colored lights reflected by the pellets.

Referring to FIG. 5, the transmission module 50 includes a fixing base 51, a second driving member 52, a third driving member 53, a pushing block 54, a gear plate 55, and a limitation block 56. The image unit 46 is electrically connected to the second driving member 52 and the third driving member 53. The fixing base 51 is fixed to the second plate 24. The fixing base 51 includes a fixing member 511, and a carrying plate 512 connected to the fixing member 511. The carrying plate 512 supports the second driving member 52 and the third driving member 53 thereon. The second driving member 52 includes a first telescopic rod 521, and the third driving member 53 includes a second telescopic rod 531. The first telescopic rod 521 is connected to the third driving member 53, and the second telescopic rod 531 is connected to the pushing block 54. The gear plate 55 is fixed to the pushing block 54, and the gear plate 55 defines a plurality of gear teeth 551 to engage with the gear 426. Thus, when the gear plate 55 is moved, the gear 426 is rotated by engagement with the gear teeth 551, thereby driving the rotation box 44 to rotate. The limitation block 56 is located on the second plate 24 and opposite to the fixing base 51 to limit a moving distance of the pushing block 54.

In at least one embodiment, the transmission module 50 can switch among three motion states. When the transmission module 50 is in a first motion state, the first telescopic rod 521 of the second driving member 52 is retracted, and the second telescopic rod 531 of the third driving member 53 is extended. Thus, the pushing block 54 and the gear plate 55 are in a first position, and the rotation box 44 is in an unrotated position. When the transmission module 50 is in a second motion state, the first telescopic rod 521 and the second telescopic rod 531 are both extended. Thus, the pushing block 54 and the gear plate 55 are driven towards the limitation block 56 to move to a second position, and the gear plate 55 drives the rotation box 44 to rotate to a first rotated position. When the transmission module 50 is in a third motion state, the first telescopic rod 521 and the second telescopic rod 531 are both retracted. Thus, the pushing block 54 and the gear plate 55 are driven towards the fixing block 511 to move to a third position, and the gear plate 55 drives the rotation box 44 to rotate to a second rotated position.

Referring to FIG. 2, the second housing 60 is positioned under the second plate 24 of the first housing 20. The second housing 60 includes two storage containers 61 received in the opening 242. The two storage containers 61 are positioned at opposite sides of the rotation box 44. When the rotation box 44 is driven to rotate to the first rotated position, the pellets are dumped into one of the storage containers 61. When the rotation box 44 is driven to rotate to be the second rotated position, the pellets are dumped into the other storage container 61. The two storage containers 61 are used to store pellets according to the lights reflected by the pellets. For example, if the pellets in the rotation box 44 all reflect light of a predetermined color, the pellets are dumped into one of the storage containers. If there are pellets mixed in the rotation box 44 that reflect light that is a different color than the predetermined color, the pellets are dumped into the other storage container.

In operation, the pellets are first dumped into the funnel 12, and the cover 14 is covered over the inlet 122 of the funnel 12. The pellets pass though the outlet 124 and the feeding hole 3851 and land on the connection plate 384. The pushing module 30 pushes the connection plate 384 to the chute 386, thereby causing the pellets to move through the chute 386 and into the rotation box 44. Then, the illuminant 442 illuminates the transparent panel 444, and the image unit 46 detects whether all the pellets reflect light of the predetermined color. In at least one embodiment, the transmission module 50 starts in the first motion state. If the image unit 46 determines that not all of the pellets reflect the light of the predetermined color, the image unit 46 controls the transmission module 50 to switch to the second motion state. Thus, the gear plate 55 drives the gear 426 to rotate the rotation box 44 to the first rotated state, thereby dumping the pellets into one of the storage containers 61. If the image unit 46 determines that all the pellets reflect the light of the predetermined color, the image unit 46 controls the transmission module 50 to switch to the third motion state. Thus, the gear plate 55 drives the gear 426 to rotate the rotation box 44 to the second rotated state, thereby dumping the pellets into the other storage container 61.

The pellets can be easily conveyed from the funnel 12 to the corresponding storage container 61, thereby saving human cost and improving work efficiency.

It is believed that the exemplary embodiments and their advantages will be understood from the foregoing description, and it will be apparent that various changes may be made thereto without departing from the scope of the disclosure or sacrificing all of its material advantages, the examples hereinbefore described merely being preferred or exemplary embodiments of the disclosure.

What is claimed is:

1. A sifting and grading device to sift and grade pellets according to colors of the pellets, the sifting and grading device comprising:
an accommodation module for accommodating the pellets; and
a pushing module connected to the accommodation module for receiving the pellets output from the accommodation module; and
a detection module connected to the pushing module, and comprising a rotation box and an image unit, the rotation box carrying the pellets conveyed by the pushing module, the image unit detecting reflect colors of the pellets; and
a transmission module directed by the image unit and coupled to the rotation box, the image unit controlling the transmission module to drive the rotation box to rotate towards different directions according to the reflect colors of the pellets.

2. The sifting and grading device of claim 1, further comprising a first housing, wherein the first housing comprises a first plate, the first plate defines a mounting hole, the accommodation module comprises a funnel and a fixing plate, a wide end of the funnel defines a inlet, a narrow end of the funnel defines a outlet, a size of the inlet is greater than a size of the outlet, the fixing plate is fixed to the first plate and the narrow end of the is received in the mounting hole.

3. The sifting and grading device of claim 2, wherein the first housing comprises a second plate, the pushing module comprises a plurality of supporting pillars, a supporting plate, a first driving member and a pushing assembly, the supporting pillars support the supporting plate above the second plate, the first driving member and the pushing assembly are supported on the supporting plate.

4. The sifting and grading device of claim 3, wherein the pushing assembly comprises a two pushing rods, a connection block, a connection plate, an accommodation block and a chute, the pushing rods is connected to the first driving member, the connection block is fixed to the pushing rods, the connection block is fixed to the connection block, the accommodation block defines a feeding hole coupled to the outlet, the chute is fixed to the accommodation block.

5. The sifting and grading device of claim 4, wherein the second plate of the first housing defines an opening, the detection module comprises a base, the base comprises two fixing blocks fixed to the second plate and positioned at opposite sides of the opening, the rotation box is positioned below an end of the chute and above the opening.

6. The sifting and grading device of claim 5, wherein the base comprises two connection rods, a first end of each connection rods is rotatably connected to the corresponding fixing block, and a second end of the each connection rod is connected to the rotation box, one of the connection rod extends through the corresponding fixing block and is rotatably connected to a gear.

7. The sifting and grading device of claim 5, wherein the rotation box further comprises an illuminant and a transparent panel illuminated by the illuminant, the transparent panel carries the pellets, the image unit is positioned above the rotation box and fixed to the first plate.

8. The sifting and grading device of claim 6, wherein the transmission module comprises a fixing base, a second driving member, a third driving member, a pushing block, a gear plate and a limitation block, the image unit is electrically connected to the second driving member and the third driving member, the limitation block is located on the second plate and opposite to the fixing base, the gear plate is fixed to the pushing block and one end of the gear plate defines a plurality of gear teeth to engage with the gear to drive the rotation box to rotate.

9. The sifting and grading device of claim 8, further comprising a second housing positioned under the second plate, wherein the second housing comprises two storage containers, the two storage containers are positioned at opposite sides of the rotation box.

10. The sifting and grading device of claim 8, wherein the second driving member comprises a first telescopic rod and the third driving member comprises a second telescopic rod, when the first telescopic rod and the second telescopic rod are both retracted, the pushing block pushes the gear plate to move towards the fixing block to drive the rotation box to rotate towards one storage container; when the first telescopic rod and the second telescopic rod are both extended, the pushing block and the gear plate are driven to move towards the limitation block to drive the rotation box to rotate towards the other storage container.

11. A sifting and grading device to sift and grade pellets according to colors of the pellets, the sifting and grading device comprising:
an accommodation module; and
a pushing module connected to the accommodation module; and
a detection module comprising a rotation box and an image unit located above the rotation box to detect colors of reflection lights of the pellets; and
a transmission module;
wherein the accommodation module accommodates pellets and conveys the pellets to the pushing module; the pushing module conveys the pellets to the detection module; the image unit is electrically connected to the transmission module to control movement of the transmission module according to the reflect colors of the pellets, the transmission module drives the rotation box to rotate towards different directions.

12. The sifting and grading device of claim 11, further comprising a first housing, wherein the first housing comprises a first plate, the first plate defines a mounting hole, the accommodation module comprises a funnel and a fixing plate, a wide end of the funnel defines a inlet, a narrow end of the funnel defines a outlet, a size of the inlet is greater than a size of the outlet, the fixing plate is fixed to the first plate and the narrow end of the is received in the mounting hole.

13. The sifting and grading device of claim 12, wherein the first housing comprises a second plate, the pushing module comprises a plurality of supporting pillars, a supporting plate, a first driving member and a pushing assembly, the supporting pillars support the supporting plate above the second plate, the first driving member and the pushing assembly are supported on the supporting plate.

14. The sifting and grading device of claim 13, wherein the pushing assembly comprises a two pushing rods, a connection block, a connection plate, an accommodation block and a chute, the pushing rods is connected to the first driving member, the connection block is fixed to the pushing rods, the connection block is fixed to the connection block, the accommodation block defines a feeding hole coupled to the outlet, the chute is fixed to the accommodation block.

15. The sifting and grading device of claim 14, wherein the second plate of the first housing defines an opening, the detection module comprises a base, the base comprises two fixing blocks fixed to the second plate and positioned at opposite sides of the opening, the rotation box is positioned below an end of the chute and above the opening.

16. The sifting and grading device of claim 15, wherein the base comprises two connection rods, a first end of each connection rods is rotatably connected to the corresponding fixing block, and a second end of the each connection rod is connected to the rotation box, one of the connection rod extends through the corresponding fixing block and is rotatably connected to a gear.

17. The sifting and grading device of claim 15, wherein the rotation box further comprises an illuminant and a transparent panel illuminated by the illuminant, the transparent panel carries the pellets, the image unit is positioned above the rotation box and fixed to the first plate.

18. The sifting and grading device of claim 16, wherein the transmission module comprises a fixing base, a second driving member, a third driving member, a pushing block, a gear plate and a limitation block, the image unit is electrically connected to the second driving member and the third driving member, the limitation block is located on the second plate and opposite to the fixing base, the gear plate is fixed to the pushing block and one end of the gear plate defines a plurality of gear teeth to engage with the gear to drive the rotation box to rotate.

19. The sifting and grading device of claim 18, further comprising a second housing positioned under the second plate, wherein the second housing comprises two storage containers, the two storage containers are positioned at opposite sides of the rotation box.

20. The sifting and grading device of claim 18, wherein the second driving member comprises a first telescopic rod and the third driving member comprises a second telescopic rod, when the first telescopic rod and the second telescopic rod are both retracted, the pushing block pushes the gear plate to move towards the fixing block to drive the rotation box to rotate towards one storage container; when the first telescopic rod and the second telescopic rod are both extended, the pushing block and the gear plate are driven to move towards the limitation block to drive the rotation box to rotate towards the other storage container.

21. A sifting and grading device configured to sift and grade pellets according to the color of the pellets, the device comprising:
a receiving portion configured to receive and hold pellets; a pushing device coupled to the receiving portion and configured to receive the pellets output from the receiving portion; and
a detector coupled to the pushing device and comprising:
a rotation box carrying the pellets conveyed by the pushing device, and
an image unit configured to detect reflected colors of pellets; and
a transmission module controlled by the image unit and coupled to the rotation box, wherein the image unit is configured to control the transmission module to rotate the rotation box towards different directions according to a detected reflected color of the pellets.
